(19) United States
(12) Patent Application Publication
(10) Pub. No.: US 2018/0060787 A1
(43) Pub. Date: Mar. 1, 2018

(54) INFORMATION PROCESSING METHOD, INFORMATION PROCESSING DEVICE AND CLIENT TERMINAL

(71) Applicant: FUJITSU LIMITED, Kawasaki-shi (JP)

(72) Inventors: Masahide NODA, Kawasaki (JP); TAKUMI BABA, Kawasaki (JP); Kei TAIRA, Kita (JP); Motoshi Sumioka, Kawasaki (JP); Takashi Ohno, Kobe (JP)

(73) Assignee: FUJITSU LIMITED, Kawasaki-shi (JP)

(21) Appl. No.: 15/672,966

(22) Filed: Aug. 9, 2017

(30) Foreign Application Priority Data
Aug. 25, 2016 (JP) 2016-164876

(51) Int. Cl. G06Q 10/06; G06F 3/0481

(52) U.S. Cl. CPC G06Q 10/063112; G06Q 10/06312; G06F 3/04817; G06Q 10/0633; G06Q 10/06316

(57) ABSTRACT

An information processing method includes: detecting, by a computer, an execution, by a worker, of a first task not included in a first task flow or a second task that is a task included in the first task flow and is other than a task assigned to the worker; receiving input of the first task or the second task; reflecting a change based on the first task or the second task in the first task flow; and storing difference information on a difference from the first task flow based on reflection of the change in a memory in association with the worker.

### CROSS-REFERENCE TO RELATED APPLICATION

This application is based upon and claims the benefit of priority of the prior Japanese Patent Application No. 2016-164876, filed on Aug. 25, 2016, the entire contents of which are incorporated herein by reference.

### FIELD

The embodiments discussed herein are related to an operation execution supporting system.

### BACKGROUND

In a task flow system as an operation execution supporting system, work processes of workers are managed as repeatable operation activities.

A related technology is disclosed in Japanese Laid-open Patent Publication No. 2008-234552, Japanese Laid-open Patent Publication No. 09-22433, or Japanese Laid-open Patent Publication No. 09-171529.

### SUMMARY

According to an aspect of the embodiments, an information processing method includes: detecting, by a computer, an execution, by a worker, of a first task not included in a first task flow or a second task that is a task included in the first task flow and is other than a task assigned to the worker; receiving input of the first task or the second task; reflecting a change based on the first task or the second task in the first task flow; and storing difference information on a difference from the first task flow based on reflection of the change in a memory in association with the worker.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an operation execution supporting system;

FIG. 2 illustrates an example of transitions of a screen displayed on a client;

FIG. 3A illustrates an example of screen transitions in rearrangement of tasks;

FIG. 3B illustrates an example of screen transitions in rearrangement of tasks;

FIG. 4 illustrates an example of tables stored in an execution state storage unit;

FIG. 5 illustrates an example of hardware configuration of an information processing device;

FIG. 6 illustrates an example of processing of detecting an extra-flow action;

FIG. 7 illustrates an example of processing of an execution flow modifying unit; and

FIG. 8 illustrates another example of an operation execution supporting system.

### DESCRIPTION OF EMBODIMENTS

For example, in a task flow in which a work procedure for implementing an operation is designed, the work procedure is assigned to a worker as needed based on the designed task flow, and the worker is requested to perform work. Using a task flow system, a manager grasps the state of the requested work, and manages progress until completion of the operation by assigning, upon completion of a piece of work, next piece of work to the worker.

As an example, a project management supporting device displays, on a display device, information which is to be called call attention of a user due to a change in a work process. Thus, user judgment is supported with regard to deletion, addition, alteration, or the like of a work process of a project.

As an example, a dynamic plan managing device modifies or stores work flow data, and grasps the progress state of a work flow based on a change in a work state. The dynamic plan managing device displays a work instruction to a person in charge for a work unit assigned based on the work flow data, and a change in a work state is made by the person in charge. Latest work flow data is collected and displayed in relation to each work flow and a related work flow selected based on plan data such as dependence relation between work flows. Therefore, plan management is performed which gives a work instruction in response to a change in the work state of the work flow.

As an example, the dynamic plan managing device displays a plurality of plan data management units each constituted of a set of plan data for determining one work plan, such as work flow data, dependence relation or reference relation between work flows or a kind of category.

As an example, when an operation is designed as a task flow, a manager does not necessarily grasp actual work completely, and the created task flow is not necessarily perfect. Therefore, depending on a situation, there may occur a case where the designed task flow is not applied to the operation because of a lack of tasks to be performed or a case where inappropriate order of tasks to be performed results in poor efficiency even when the designed task flow is applied.

As an example, the design of a task flow in accordance with the actual situation of a worker may be simplified.

An operation execution supporting system makes a database of actions of workers which actions are not performed according to a task, flow at a time of design, for example, changes in work order. Therefore, a manager may readily change the design of the original task flow in accordance with the actual situation. As an example, the operation execution supporting system may present, to a worker, a task flow changed (customized) in accordance with a previous action.

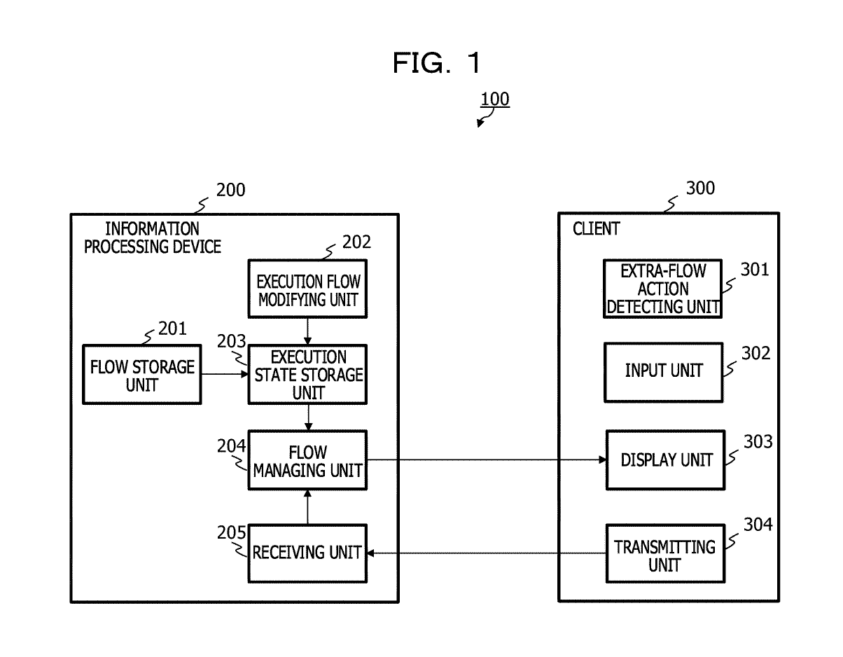

FIG. 1 illustrates an example of an operation execution supporting system. An operation execution supporting system 100 includes an information processing device 200 and a client 300. The information processing device 200 is an operation execution supporting device that manages processing of a task flow including designed work order, workers assigned to work units, progress information, or the like. The client 300 is a terminal used by a worker who uses the operation execution supporting system 100.

The information processing device 200 includes a flow storage unit 201, an execution flow modifying unit 202, an execution state storage unit 203, a flow managing unit 204, and a receiving unit 205. The flow storage unit 201 stores a task flow including designed work order, workers assigned to work units, progress information, or the like. The flow managing unit 204 manages the flow displayed on the side of the client 300 used by the worker. The receiving unit 205 receives progress information of the worker on the side of the client 300. The execution flow modifying unit 202 and the execution state storage unit 203 operate in processing related to tasks outside the task flow.

The client 300 includes an extra-flow action detecting unit 301, an input unit 302, a display unit 303, and a transmitting unit 304. The display unit 303 displays information on work to be performed next by the worker based on information related to the task flow which information is obtained from the flow managing unit 204. The input unit 302 receives input of progress information or the like that is input by the worker according to the work. The transmitting unit 304 transmits information such as the progress information input to the input unit 302 to the information processing device 200. The extra-flow action detecting unit 301 operates in processing related to tasks outside the task flow.

The worker performs work according to the task flow displayed on the client 300. However, tasks of the task flow may be inefficient or may be inappropriate. Therefore, the worker may perform work outside the task flow without following the tasks displayed on the client 300.

The extra-flow action detecting unit 301 in the client 300 detects an action unrelated to a task displayed on the display unit 303. The extra-flow action detecting unit 301 may, for example, detect that the worker is performing an action unrelated to the task when an operation for a start, a postpone, or the like of the task displayed on the display unit 303 is not received by the input unit 302 for a certain time. The extra-flow action detecting unit 301 may detect that the worker is performing an action unrelated to the task when detecting that the worker is not using resources, for example, an application, associated with the task displayed on the display unit 303. The extra-flow action detecting unit 301 may detect that the worker is performing an action unrelated to the task when the worker depresses a button indicating that an action unrelated to the task is performed by using the input unit 302, for example.

When the extra-flow action detecting unit 301 in the client 300 detects that the worker is performing an action unrelated to the task, the display unit 303 displays a task content input screen for inputting the extra-flow action. The input unit 302 receives input of a task name, task contents, and the like as the extra-flow action on the task content input screen from the worker. The input unit 302 may select extra-flow actions from existing tasks, and receive input. The input unit 302 receives input for processing of rearrangement, deletion or the like of the task. The transmitting unit 304 transmits, to the information processing device 200, information related to the extra-flow action input to the input unit 302.

The execution flow modifying unit 202 in the information processing device 200 receives the information related to the extra-flow action from the side of the client 300. The execution flow modifying unit 202 adds the received information related to the extra-flow action as a new task in place of the task displayed on the client 300. The execution state storage unit 203 stores the task flow to which the new task is added in association with the worker who input the extra-flow action. As an example, because the designed task flow is already stored in the flow storage unit 201, the execution state storage unit 203 may store the newly added task as difference information.

When the flow managing unit 204 reads the task flow, the flow managing unit 204 reads the designed task flow from the flow storage unit 201, then reads a difference task corresponding to the worker from the execution state storage unit 203, and transmits the designed task flow and the difference task to the side of the client 300. Because activities in operations may be thus changed in worker units, the design of a task flow in accordance with the actual situation of a worker may be made easily.

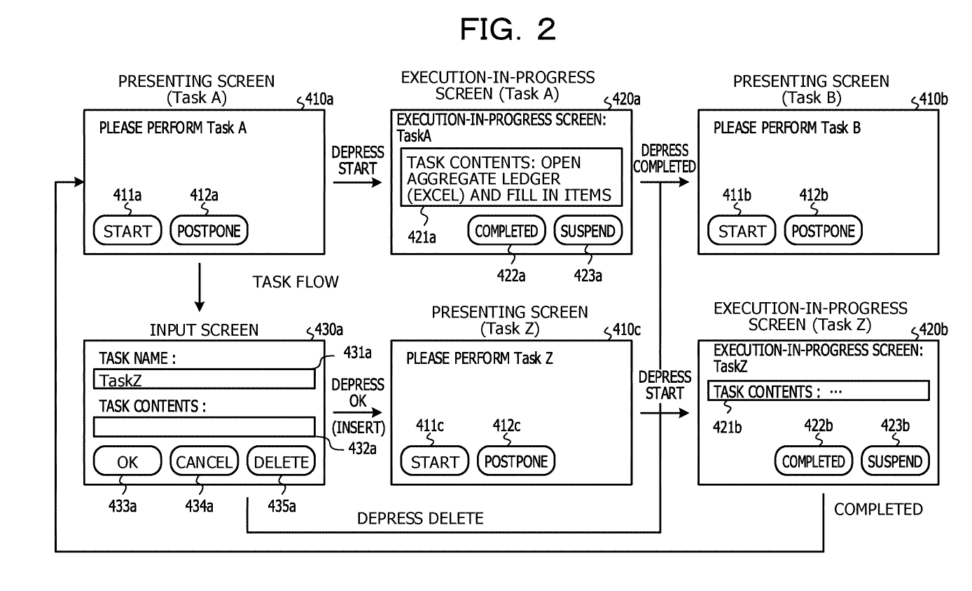

FIG. 2 illustrates an example of transitions of a screen displayed on a client. In the following processing, the information processing device 200 presents, to a client 300 (worker), a task flow that makes a worker execute tasks in order of Task A, Task B, Task C, and Task D, for example. A presenting screen 410a may be an example of a screen displayed on the display unit 303 as a screen prompting the worker to start executing Task A. When the presenting screen 410a is displayed, the worker depresses either a start button 411a indicating a start of the task or a postpone button 412a for skipping the task.

When the start button 411a is depressed, the display unit 303 displays an execution-in-progress screen 420a displayed while the task is executed. The execution-in-progress screen 420a includes: task contents 421a representing the contents of the task to be executed by the worker; a task completion button 422a depressed when the worker completes the task; and a suspension button 423a depressed when the worker suspends the task. When the task completion button 422a is depressed, the display unit 303 displays a presenting screen 410b prompting for a start of execution of Task B, which is a task following Task A.

When the extra-flow action detecting unit 301 detects an extra-flow action while the presenting screen 410a is displayed, the display unit 303 displays an input screen 430a. The input screen 430a includes: a form 431a for inputting a task name; a form 432a for inputting concrete contents of a task; an OK button 433a for the worker to register the task name and the task contents and add the new task to the task flow; a cancellation button 434a for canceling the addition of the task; and a deletion button 435a for deleting the task.

When the deletion button 435a is depressed on the input screen 430a, the transmitting unit 304 transmits information for deleting Task A to the information processing device 200. The execution state storage unit 203 stores information indicating the deletion of Task A from the task flow in correspondence with the worker. Consequently, when the subsequent task flow is executed, the display unit 303 does not display the presenting screen 410a for Task A. The display unit 303 thereafter displays the presenting screen 410b prompting for a start of execution of Task B, which is, a task following Task A.

When the OK button 433a is depressed after task contents corresponding to a task name “Task Z” of a new task are input on the input screen 430a, the transmitting unit 304 transmits information for adding the new Task Z to the task flow to the information processing device 200. The execution state storage unit 203 stores information indicating the addition of Task Z immediately before Task A. Therefore, when the subsequent task flow is executed, the display unit 303 displays a presenting screen 410c prompting for execution of Task Z before Task A. After the new Task Z is registered, the display unit 303 displays the presenting screen 410c prompting for the execution of Task Z.

After the worker then executes Task Z (an execution-in-progress screen 420b is displayed), the display unit 303 displays the presenting screen 410a prompting for a start of the execution of Task A, which has become the task following Task Z.

Thus, when the client 300 detects an extra-flow action during task work of the worker, the client 300 displays the input screen 430, and prompts the worker to register the task being executed instead. When the task actually performed by the worker is input, the client 300 transmits information on the new task to the side of the information processing device 200. The information processing device 200 stores the new task flow corresponding to the worker, and prompts the worker to perform tasks based on the new task flow. Because activities in operations may be thus changed in worker units, the design of a task flow in accordance with the actual situation of a worker may be made easily.

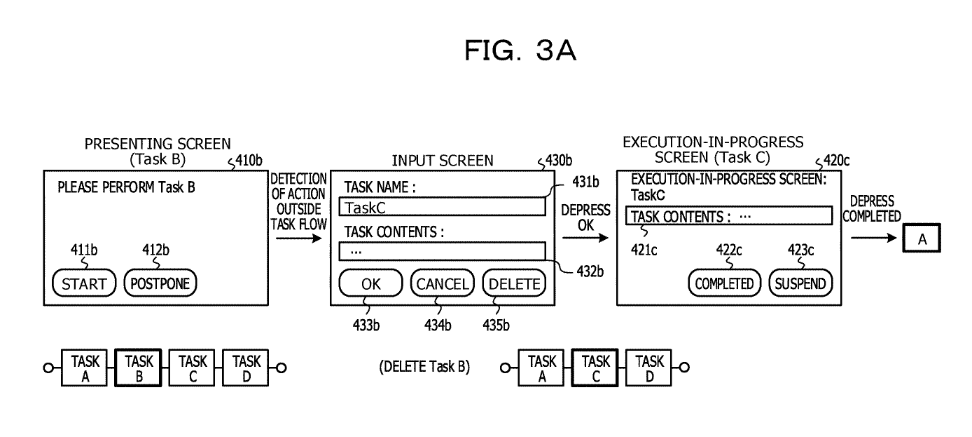

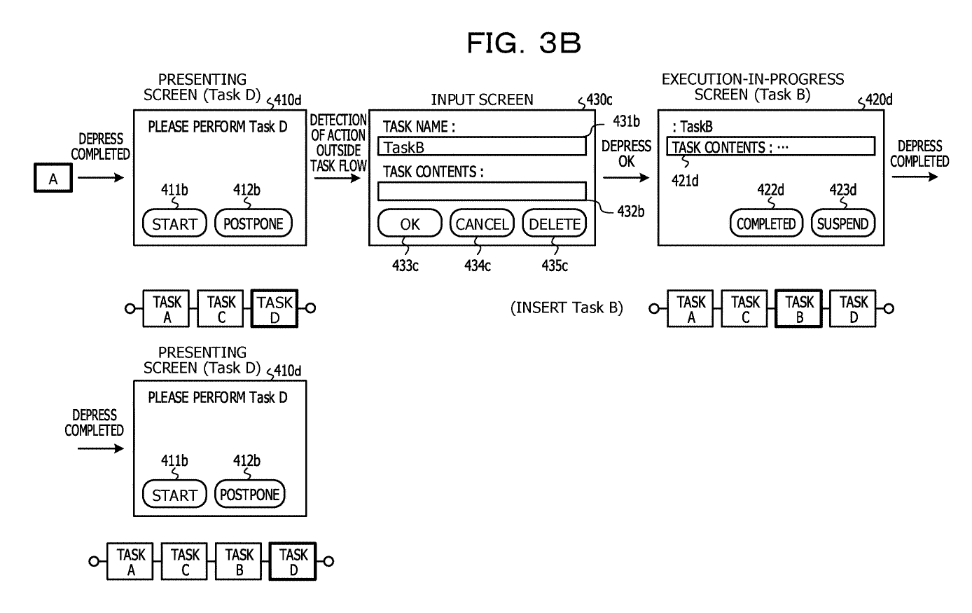

FIG. 3A and FIG. 3B illustrate an example of screen transitions in rearrangement of tasks. Suppose, for example, that a worker is assigned a task flow that makes the worker execute tasks in order of Task A, Task B, Task C, and Task D, and that the worker is at a time of a start of execution of Task B. The worker may, for example, desire to perform work in which Task B and Task C are interchanged,

A presenting screen 410b may be an example of a screen displayed on the display unit 303 as a screen prompting the worker to start executing Task B. When the extra-flow action detecting unit 301 detects an extra-flow action, the display unit 303 displays an input screen 430b.

In order to interchange Task B and Task C, the worker inputs Task C as a task name 431b on the input screen 430b, inputs task contents corresponding to Task C, and depresses an OK button 433b. The transmitting unit 304 transmits information for adding Task C immediately before Task B to the information processing device 200.

When the execution flow modifying unit 202 of the information processing device 200 determines that Task C is already included in the task flow, the execution flow modifying unit 202 determines whether or not Task C input in the task flow is a task following the task now being presented on the client 300. Task C input in the task flow is a task following Task B now being presented on the client 300. Thus, the execution flow modifying unit 202 determines that Task B (task being displayed now) is to be deleted. The execution state storage unit 203 stores information indicating the deletion of Task B from the task flow. Therefore, the flow managing unit 204 assigns the task flow including Task A, Task C, and Task D to the client 300.

Because the information for executing Task C is input on the input screen 430b, the display unit 303 displays an execution-in-progress screen 420c, which is displayed during the execution of Task C. When the execution of Task C is completed and a completion button 422c is depressed, the display unit 303 displays a presenting screen 410d prompting for execution of Task D following. Task C.

The worker performs no processing on the presenting screen 410d to add Task B before Task D. Therefore, the extra-flow action detecting unit 301 detects an extra-flow action, and the display unit 303 displays an input screen 430c. Then, to add Task B before Task D, the worker inputs Task B as a task name 431c on the input screen 430c, inputs task contents corresponding to Task B, and depresses an Clk button 433c.

The execution flow modifying unit 202 of the information processing device 200 determines that Task B is to be added immediately before Task D. The execution state storage unit 203 stores information indicating the addition of Task. B immediately before Task D in association with the worker. As a result, the task flow corresponding to this worker is a task flow assigned in order of Task A, Task C, Task B, and Task D.

Because the information for executing Task B is input on the input screen 430c, the display unit 303 displays an execution-in-progress screen 420d, which is displayed while Task B is executed. When the execution of Task B is completed and a completion button 422d is depressed, the display unit 303 displays the presenting screen 410d prompting for the execution of Task D following Task B.

Thus, in the above-described task system, tasks in a task flow are interchanged by deletion and addition of a task or tasks.

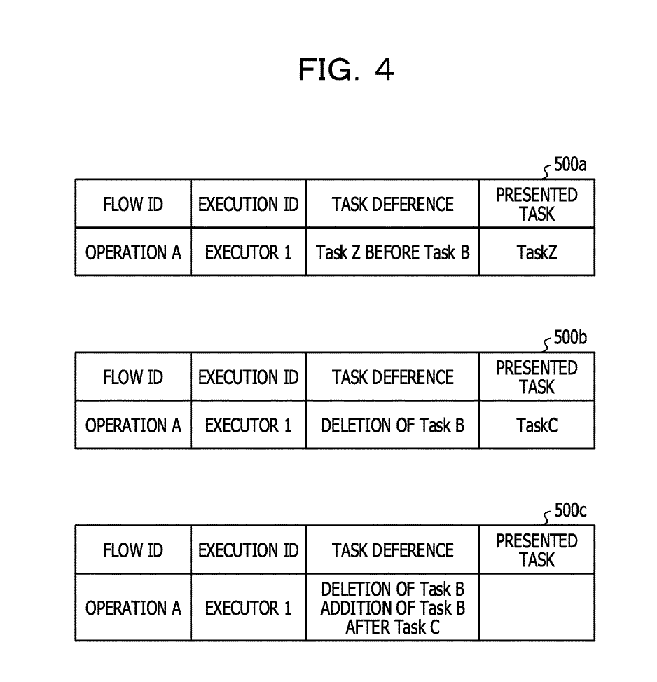

FIG. 4 illustrates an example of tables stored in an execution state storage unit. The execution state storage unit 203 stores a difference from a designed task flow as a difference table. Difference tables 500a to 500c each include items of a flow identifier (ID), an execution ID, a task difference, and a presented task. The flow ID represents identification information identifying a task flow having a task changed by input of a worker. The execution ID represents identification information identifying the worker. The task difference represents difference information on a difference from the designed task flow based on the input of the worker. The presented task represents information indicating a task now displayed on the client 300 in the task flow corresponding to the worker.

The difference table 500a represents an example of a difference table in a case where a task is added. The difference table 500a retains an “operation A” as the item of a flow ID, an “executor 1” as the item of an execution ID, “Task Z before Task B” as the item of a task difference, and a presented task “Task Z,” When the worker “executor 1” using the client 300 executes tasks related to the task flow of the “operation A,” the flow managing unit 204 adds Task. Z before Task B in the task flow of the operation A, and presents the resulting task flow to the worker.

The difference table 500b represents an example of a difference table in a case where a task is deleted. The difference table 500b retains an “operation A” as the item of a flow ID, an “executor 1” as the item of an execution ID, “deletion of Task B” as the item of a task difference, and a presented task “Task C.” When the worker “executor 1” using the client 300 executes tasks related to the task flow of the “operation A,” the flow managing unit 204 deletes Task B in the task flow of the operation A, and presents the resulting task flow to the worker.

The difference table 500c represents an example of a difference table in a case where Task B and Task C are rearranged. The difference table 500c retains an “operation A” as the item of a flow ID, an “executor 1” as the item of an execution ID, and “deletion of Task. B and addition of Task B after Task C” as the item of a task difference. When the worker “executor 1” using the client 300 executes tasks related to the task flow of the “operation A,” the flow managing unit 204 rearranges the order of Task B and Task C by once deleting Task B in the task flow of the operation A and adding Task B after Task C, and presents the resulting task flow to the worker.

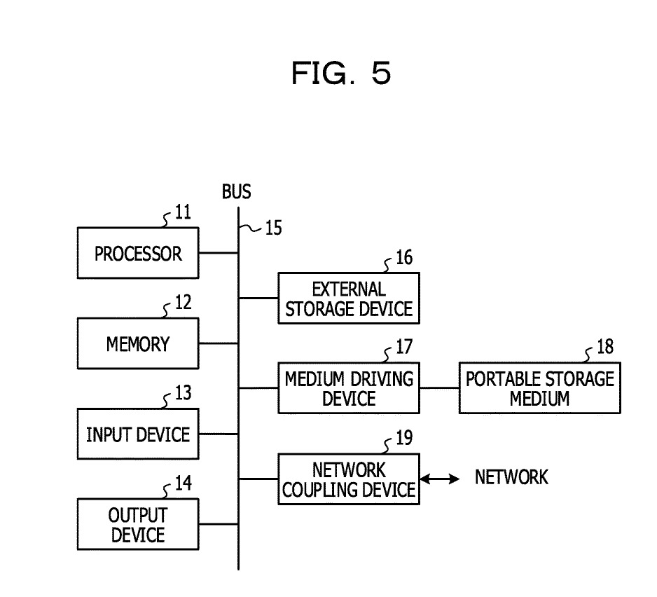

FIG. 5 illustrates an example of hardware configuration of an information processing device. The information processing device 200 includes a processor 11, a memory 12, a bus 15, an external storage device 16, and a network coupling device 19. The information processing device 200 may further include an input device 13, an output device 14, and a medium driving device 17. The information processing device 200 may, for example, be a computer.

The processor 11 may be an arbitrary processing path including a central processing unit (CPU). The processor 11 operates as the execution flow modifying unit 202 and the flow managing unit 204. The processor 11 may execute a program stored in the external storage device 16, for example. The memory 12 operates as the flow storage unit 201 and the execution state storage unit 203, and stores the difference table 500. The memory 12 also stores data obtained by operation of the processor 11 and data used in processing of the processor 11 as appropriate. The network coupling device 19 is used for communication with another device.

The input device 13 may include, for example, buttons, a keyboard, a mouse or the like. The output device 14 may include a display or the like. The bus 15 establishes coupling between the processor 11, the memory 12, the input device 13, the output device 14, the external storage device 16, the medium driving device 17, and the network coupling device 19 so as to enable mutual transfer of data therebetween. The external storage device 16 stores a program, data, and the like, and provides the stored information to the processor 11 or the like as appropriate. The medium driving device 17 outputs data in the memory 12 and the external storage device 16 to a portable storage medium 18, and reads a program, data, and the like from the portable storage medium 18. The portable storage medium 18 may be an arbitrary portable storage medium including a floppy disk, a magneto-optical (MO) disk, a compact disk recordable (CD-R), and a digital versatile disk recordable (DVD-R).

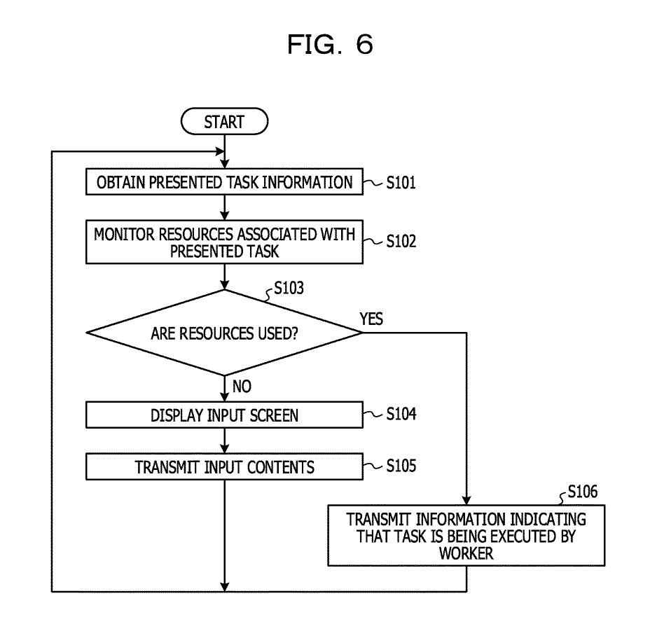

FIG. 6 illustrates an example of processing of detecting an extra-flow action. The extra-flow action detecting unit 301 obtains task information now presented on the display unit 303 (operation S101). The extra-flow action detecting unit 301 starts to monitor the usage state of resources corresponding to the presented task (operation S102). The extra-flow action detecting unit 301 determines whether or not the resources corresponding to the presented task are used (operation S103).

When the resources corresponding to the presented task are not used (NO in operation S103), the display unit 303 displays an input screen 430 (operation S104). The transmitting unit 304 transmits input contents input to the input screen 430 to the information processing device 200 (operation S105). After operation S105 is ended, the processing from operation S101 is repeated.

When the resources corresponding to the presented task are used (YES in operation S103), the transmitting unit 304 transmits information indicating that the task is being executed by the worker to the information processing device 200 (operation S106). After operation S106 is ended, the processing from operation S101 is repeated.

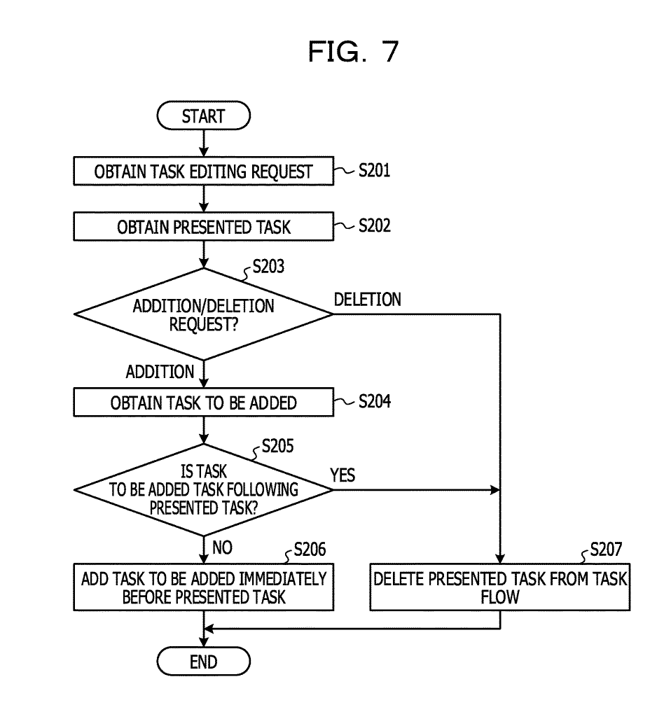

FIG. 7 illustrates an example of processing of an execution flow modifying unit. The execution flow modifying unit 202 obtains, from the receiving unit 205, a task modifying request based on input contents sent from the transmitting unit 304 (operation S201). The execution flow modifying unit 202 obtains a presented task, which is a task being presented on the side of the client 300 (operation S202). The execution flow modifying unit 202 determines whether the task modifying request is a task addition request or a task deletion request (operation S203).

When determining in operation S203 that he task modifying request is a task addition request, the execution flow modifying unit 202 obtains task contents to be added (operation S204). The execution flow modifying unit 202 determines whether or not the task to be added is a task following the presented task (operation S205). When the task to be added is not the task following the presented task (NO in operation S205), the execution flow modifying unit 202 stores, in the execution state storage unit 203, a difference indicating the addition of the task to be added before the presented task (operation S206). After operation S206 is ended, the execution flow modifying unit 202 ends the processing based on the task modifying request.

When determining in operation S203 that the task modifying request is a task deletion request, or when the task to be added is the task following the presented task (YES in operation S205), the execution flow modifying unit 202 stores difference information indicating the deletion of the presented task in the execution state storage unit 203 (operation S207). After operation S207 is ended, the execution flow modifying unit 202 ends the processing based on the task modifying request.

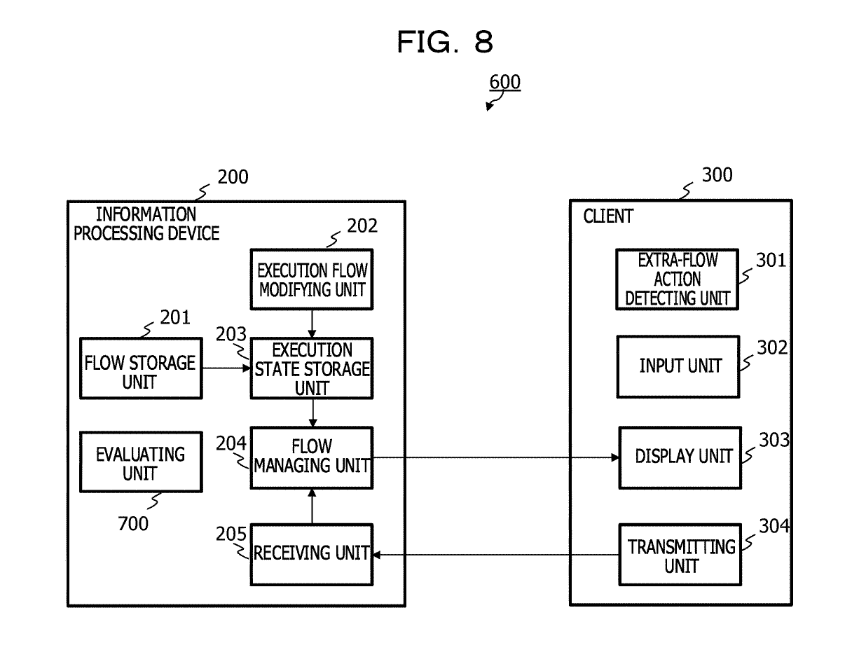

FIG. 8 illustrates another example of an operation execution supporting system. In an operation execution supporting system 600 illustrated in FIG. 8, substantially the same elements as or similar elements to those of the operation execution supporting system 100 in FIG. 1 are identified by the same reference numerals. As an example, the operation execution supporting system 600 further includes an evaluating unit 700 in the information processing device 200 in the operation execution supporting system 100 of FIG. 1.

The evaluating unit 700 evaluates a changed task flow. A result of the evaluation may be presented to the output device 14 included in the information processing device 200. The evaluating unit 700 evaluates the changed task flow based on an item such as time, quality or cost. For example, the evaluating unit 700 measures a work time from a start to completion of a worker using the changed task flow, and compares the work time with a work time from a start to completion of the worker using the task flow that is not changed. The evaluating unit 700 evaluates quality based on the finished quality, accuracy, design, or the like of an operation product. The evaluating unit 700 performs the evaluation based on cost such as expenses, the number of people or an amount of resources taken to complete the operation.

The evaluation result may be viewed by all workers using the client 300. Therefore, a worker may change the task flow of the worker himself/herself to a task flow receiving a good evaluation. In this case, the execution state storage unit 203 adds identification information identifying the worker to the task flow receiving the good evaluation, and stores the task flow.

The evaluation result may be viewed by a manager who designs the task flow itself on the information processing device 200. The manager may reflect the task flow receiving the good evaluation in the flow storage unit 201 based on the evaluation result.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-implemented work flow management method for managing task flows, each task flow including a plurality of tasks, the method comprising:
detecting, by a computer, an execution, by a worker, of a first task not included in a first task flow or a second task that is a task included in the first task flow and is other than a task assigned to the worker;
receiving input of the first task or the second task from a client terminal;
identifying a change within the first task flow based on the first task or the second task received from the client terminal; and
storing, in a memory, difference information on a difference from the first task flow in association with the worker based on the identified change.

2. The computer-implemented work flow management method according to claim 1, further comprising:
evaluating a second task flow in which contents of the identified change are reflected; and
storing the difference information in the memory in association with a different worker from the worker based on an evaluation result.

3. The computer-implemented work flow management method according to claim 1, wherein
the detecting is performed based on whether or not resources associated with the task assigned to the worker are used.

4. The computer-implemented work flow management method according to claim 1, wherein
the detecting is performed based on whether or not an operation for the task assigned to the worker is performed during a certain time period.

5. The computer-implemented work flow management method according to claim 1, wherein,
the detecting is performed based on whether or not a particular operation for the task assigned to the worker is performed.

6. The computer-implemented work flow management method according to claim 1, wherein
the input of the second task is selected from tasks included in the first task flow.

7. An operation execution supporting device to manage task flows, each task flow including a plurality of tasks, the device comprising:
a memory configured to store a program; and
a processor configured to perform a process based on the program,
wherein the process includes:
detecting an execution, by a worker, of a first task not included in a first task flow or a second task that is a task, included in the first task flow and is other than a task assigned to the worker;
receiving input of the first task or the second task;
identifying a change within the first task flow based on the first task or the second task; and
storing, in the memory, difference information on a difference from the first task flow in association with the worker based on the identified change.

8. The device according to claim 7, wherein the process includes:
evaluating a second task flow in which contents of the identified change are reflected; and
storing the difference information in the memory in association with a different worker from the worker based on an evaluation result.

9. The device according to claim 7, wherein
the detecting is performed based on whether or not resources associated with the task assigned to the worker are used.

10. The device according to claim 7, wherein
the detecting is performed based on whether or not an operation for the task assigned to the worker is performed during a certain time period.

11. The information processing device according to claim 7, wherein
the detecting is performed based on whether or not a particular operation for the task assigned to the worker is performed.

12. The information processing device according to claim 7, wherein
the input of the second task is selected from tasks included in the first task flow.

13. A client terminal comprising:
an input-output device; and
a processor configured to perform processing,
wherein the processing includes:
receiving a first task flow from an information processing device which manages a task flow, each task flow including a plurality of tasks;
detecting an execution, by a worker, of a first task not included in the first task flow or a second task that is a task included in the first task flow and is other than a task assigned to the worker;
receiving input of the first task or the second task from the input-output device; and
transmitting information based on the first task or the second task to the information processing device in order for the information processing device to generate a second task flow reflecting a change within the first task flow based on the first task or the second task.

14. The client terminal according to claim wherein the processing includes:
evaluating a second task flow in which contents of the change are reflected; and
storing the difference information in the memory in association with a different worker from the worker based on an evaluation result.

15. The client terminal according to claim 13, wherein
the detecting is performed based on whether or not resources associated with the task assigned to the worker are used.

16. The client terminal according to claim 13, wherein
the detecting is performed based on whether or not an operation for the task assigned to the worker is performed during a certain time period.

17. The client terminal according to claim 13, wherein
the detecting is performed based on whether or not a particular operation for the task assigned to the worker is performed.

18. The client terminal according to claim 13, wherein
the input of the second task is selected from tasks included in the first task flow.

19. An operation execution support system comprising:
an operation execution supporting device configured to manage task flows, each task flow including a plurality of tasks; and
a client terminal configured to display tasks of a first task flow to a user and receive input from the user on tasks assigned to the user and tasks executed by a user,
wherein the operation execution supporting device includes
a memory configured to store the task flows, and
a processor configured to manage processing of the first task flow, identify changes within the first task flow based on input from the client terminal, and generate a second task flow reflecting a change within the first task flow,
wherein the client terminal includes
an input-output device to receive the task flow from the operation execution supporting device and input from the user, and
a processor configured to detect execution, by the user, of a first task not included in the first task flow or a second task that is a task included in the first task flow and is other than a task assigned to the user and cause transmission of information based on the first task or the second task to the operation execution supporting device in order for the operation execution supporting device to generate the second task flow.
